(19) United States
(12) Patent Application Publication
(10) Pub. No.: US 2003/0130961 A1
(43) Pub. Date: Jul. 10, 2003

(54) System and method for making secure data transmissions

(76) Inventor: Ghislain Moret De Rocheprise, Massy (FR)

Correspondence Address: YOUNG & THOMPSON, 745 SOUTH 23RD STREET 2ND FLOOR, ARLINGTON, VA, 22202

(21) Appl. No.: 10/181,690

(22) PCT Filed: Jan. 19, 2001
(86) PCT No.: PCT/FR01/00172

(30) Foreign Application Priority Data
Jan. 19, 2000 (FR) 00/00664

(51) Int. Cl. G06F 17/60

(52) U.S. Cl. 705/78

(57) ABSTRACT

A system for making secure transactions by mail-order purchasing, in particular on the Internet, with delivery of a unique and non-reusable code for each completed transaction. The system involves a third party (20, 50) between the purchaser (10) and the seller (30, 60). The third party has a table (80) likewise stored in an electronic fill device (70) of the purchaser (10). The third party validates the purchase when the code, issued from the electronic fill device (70) and transmitted by the purchaser, is identical to a code present in the table located at the third party's. The code advantageously comprises the value of an incremental counter associated with a certification number randomly determined when the electronic fill device (70) is initialized.

The present invention relates to a system and a process for securing data transmissions, and in particular during mail order transactions, especially over the internet or by Minitel or over the telephone.

The sale of goods by mail order, in particular over the internet, requires an impregnable payment order transmission system. The principle which is currently most commonly applied is for the purchaser to provide his bank details via his credit card details. Increasingly, this information is encrypted to prevent fraud. Encryption can be carried out either by the internet browser software, typically using the SSL protocol, or by a dedicated software program using an algorithm such as, for example, RSA 128. It should however be noted that any encryption is considered to be decryptable. The resolution variables of a cryptography code are, as a function of the code's complexity, the calculation power applied and the time available. In numerous countries, the use of very sophisticated encryption systems is further limited by legislation allowing states to retain control where necessary over the distribution of information. The ongoing increase in the processing power of computers available to the general public therefore necessarily permanently calls into question the quality of encryption codes.

However, encryption only addresses one problem confronting data transmission over the internet, namely the risk of interception of messages between the two parties. Now, the confidentiality of a message must be complete, in particular as regards payments, throughout the chain. It is thus necessary to take into account the good faith of the trader who, having received the bank details in the clear, could use them for other purposes than those intended by the purchaser. A common case of fraud is thus the reading from stores' till receipts of the details of credit cards, in particular their owners' names, serial numbers and validity dates, which elements are considered sufficient by most mail order services to validate a purchase.

Another source of insecurity, in particular on computer networks, is the theft by hacking of databases storing the personal data of a company's customers, including their credit card numbers. In fact, the possibility of fraud by data piracy or other means remains real as long as the bank card codes are accepted by traders without any proof of the purchaser's legitimacy.

Existing alternatives are firstly payment by cheque or postal order, which are much less convenient for the customer, and refused by certain traders as they limit impulse buying. Next, the internet offers solutions based on reading bank cards' security data using card readers. This system requires the purchaser to be equipped with a suitable reader, which notably restricts his freedom of purchase. Moreover, this system improves security from the trader's point of view, as he is thus assured of the purchaser's validity, but does not change the fact that the user, whose bank card code can be pirated in different ways, or even generated by specialized software, is exposed to the continued acceptance of unsecured payments by traders. Finally there exists the solution described in U.S. Pat. No. 005,883,810 which consists of providing the purchaser a new code for each transaction, which replaces his credit card code, and matching these two codes at a later stage. However, this system remains a continuation of the use of bank cards for mail order and therefore, as in the case where a card reader is used, does not prevent the fraudulent use of a card number stolen from a customer database or from a restaurant bill.

The present invention proposes a system for securing data transmissions, and in particular during mail order purchasing transactions, allowing the aforementioned problems to be resolved.

Another purpose of the invention is to propose a transaction system which offers security both for the customer and for the trader.

A further object of the invention is a system avoiding the transmission of bank card code via a communications network.

The aforementioned objectives are achieved with a secure transaction system via a communications network, comprising a customer terminal for connecting to this communications network and transmitting a purchase request, a trader server for receiving the customer's purchase request and a transaction data item supplied by the customer, a trusted third party server for receiving and validating the transaction information in order to proceed with the payment for the purchase. According to the invention, the system comprises a processing module located on the customer's premises and comprising a customer table which contains the transaction data item, which transaction data item is unique to each transaction. Moreover, the trusted third party server contains a duplicate of this customer table. The customer table stored in the trusted third party server is such that it cannot be accessed by the communications network. The purchase request can contain a customer identification code such as for example a unique serial number provided on the processing module.

By processing module is understood an electronic unit or any other module equipped with any other type of technology such as photon, molecular or mechanical technology.

Preferably, the customer table comprises a series of purchase numbers each associated with a unique certification number. Advantageously, each certification number is a random number determined when the customer table is created. According to a variant of the invention, the table comprises a series of purchase numbers, and the electronic unit and the trusted third party server comprise an algorithm able to determine a unique certification number for each purchase number.

A person skilled in the art can choose from one version or another according to the calculation speed and the free memory available in the electronic unit. The type of algorithm can be chosen from encryption algorithms existing in the literature such as those described in the documents US4405829 and FR2756122 for example, or any other type of algorithm. It is however useful to choose an encryption algorithm which is sufficiently robust to prevent the possible interception of a

large number of codes from allowing the interceptor to determine the next code. If the designer of the unit prefers to use a simple algorithm, he can then limit the maximum number of purchase numbers on a single unit, such that knowing all these purchase numbers does not enable the algorithm used to be understood.

With such a system, the transmission of data, in particular for a mail order transaction, is secured. The invention is particularly remarkable by the fact that an electronic unit is used containing in a memory a customer table containing a series of codes, or transaction information, corresponding to a series of user requests. This customer table is known and kept secret by a single trusted third party who can advantageously be the issuer of the electronic unit. Ideally, the memory is protected such that it cannot be read in any other way than executing the processing provided by the present invention. This memory for example has no external connections to the unit, and/or access to its connectors requires the destruction of the unit. The table is thus isolated from any external communications system.

The trusted third party playing the role of a financial institution or bank or being associated with a financial institution or bank, guarantees the validity of the transaction.

The electronic unit has one or more logical circuits, typically a microprocessor, which on the one hand handles the internal management of information and on the other hand handles the calculations required by the different processes. According to a characteristic of the invention, the unit further comprises processing means for supplying a new purchase number each time it is requested, as well as a new associated certification number. In particular, these processing means can comprise an incremental counter which is incremented by one unit each time a certification number is supplied, and the purchase number can advantageously be the value of this incremental counter. The trusted third party server is also equipped with such a counter.

The electronic unit can further comprise a man/machine interface. This man machine interface can be composed on the one hand by an input device, for example a keyboard with ten keys ranging from 0 to 9 plus optionally two programmable keys, for example “Enter” and “Cancel”, or for example a microphone associated with a voice recognition and analysis circuit, or generally any type of data input for the machine. The electronic unit can also comprise a display screen, or any type of component allowing data to be transmitted to the user, or a touch-sensitive screen also serving as an input keyboard. Means of locking and unlocking access to the customer table can also be provided, unlocking being obtained using a secret code or personal identification number (PIN).

The credit card format is so widely used and so suited to daily life that it is preferable for the electronic unit to be in such a format. However, as a man/machine interface is necessary, it is advisable to use a card having a sensitive keyboard, or any technology which is thin, with 12 keys (0 to 9, “enter”, “cancel”), and a digital screen, such a card having already been described in the literature (FR 2,768,532).

As the electronic unit does not initially require any external electronic communication, the communications interface by flush contact usually required with bank smart cards is unnecessary. This interface can however appear in the case of a hybrid card supporting functions other than those described previously. It will then be important to retain the impenetrability of the memory containing the customer table either by the physical separation of the circuits inside the unit, or by an electronic separation of these circuits. There can however be an area of flush contacts, clearly defined geographically on the electronic unit, comprising two poles, either in order to supply electricity to the unit for it to operate, or in order to recharge a battery fitted within the unit. An electrical supply by a photoelectric cell or an induction field is also possible.

According to another aspect of the invention, a transaction process is proposed which is secured via a communications network, in which a customer connects, via a terminal, to a trader server in order to make a purchase. According to the invention, the process comprises the following steps:

generation of a transaction data item from a customer table stored in an electronic unit in the customer's possession, this table being isolated from the communications network,

transmission, for example via the terminal, of the transaction data item to a trusted third party server, the trusted third party server containing a duplicate of the customer table,

reception of the transaction data item by the trusted third party server and comparison of this data item with the customer table stored in the trusted third party server,

validation of the purchase when the comparison is positive.

The comparison is positive when the transaction data item is present in the customer table stored in the trusted third party server and the trusted third party server receives this trusted data item for the first time. In other words, the comparison is positive when the trusted third party server receives a purchase number and a certification number which have not yet been used. More precisely, this comparison consists in checking whether, for a purchase number contained in the transaction data item received, the associated certification number is identical to that contained in the customer table stored in this trusted third party server.

According to the invention, the trusted third party server notifies the customer of the result of the comparison.

Other advantages and characteristics of the invention will appear on examining the detailed description of a method of implementation which is in no way limitative, and the attached drawings in which:

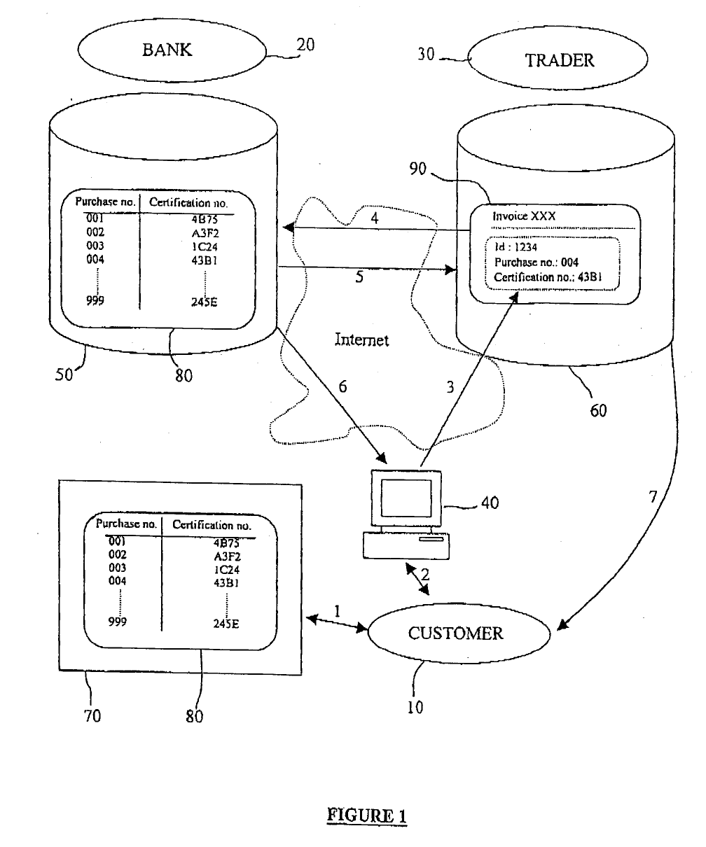

FIG. 1 is a simplified diagram illustrating the main elements of the system and the route travelled by the information exchanged;

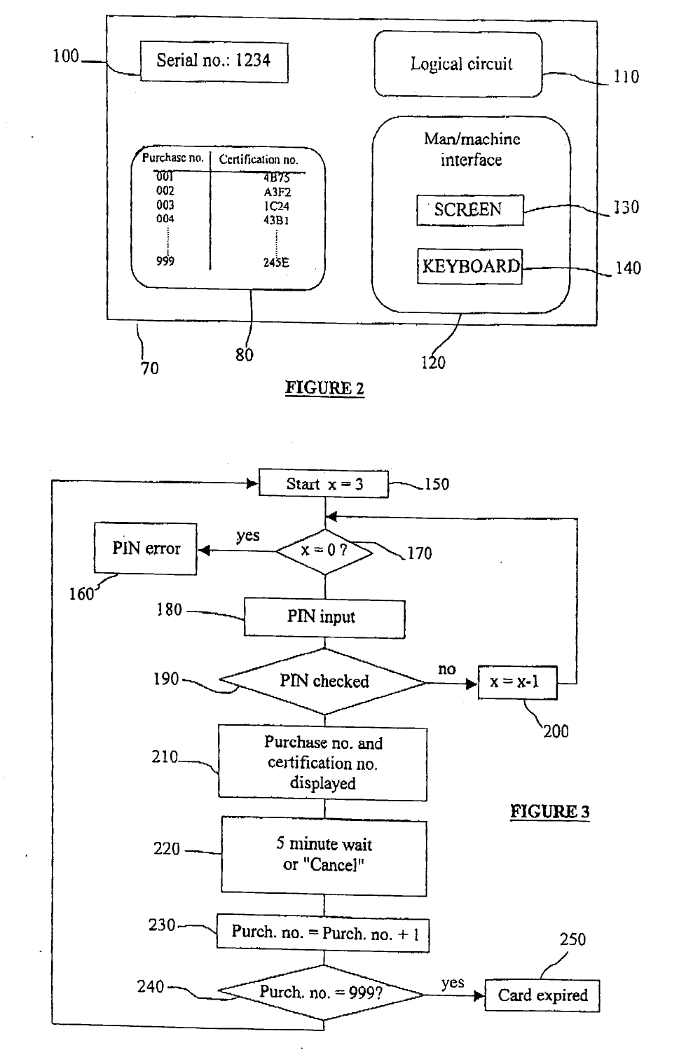

FIG. 2 is a block diagram illustrating a number of elements constituting an electronic unit according to the invention;

FIG. 3 is a flowchart of the steps for obtaining a purchase number and a certification number according to the invention; and

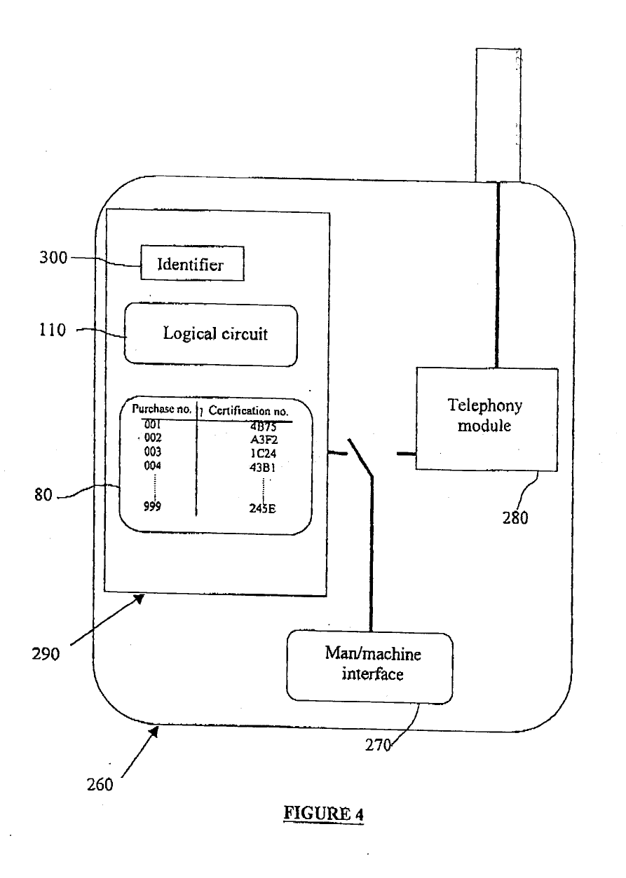

FIG. 4 is a block diagram illustrating the integration of the electronic unit into a mobile telephone.

In FIG. 1, three main entities can be seen: the customer 10, the trader 30 and the bank 20 which is acting as the trusted third party. These three entities are connected to the internet communications network respectively via a personal computer 40, a trader server 60 and a bank server 50. The customer 10 is advantageously equipped with an electronic unit 70 issued by the bank 20. Some of the elements of this unit are illustrated in FIG. 2.

In this FIG. 2, there can be seen in the electronic unit 70 a customer table 80 formed by two columns, a “Purchase no.” column composed of a series of numbers ranging from 1 to 999 and a “Certification no.” column composed of a series of randomly and uniquely predetermined codes. The unit also comprises a logical circuit 110 comprising at least one microcontroller or a microprocessor, and a man/machine interface 120 comprising in particular a screen 130 and a keyboard 140. A serial number 100 is provided on one side of this unit such that it remains constantly visible. Advantageously, as can be seen in FIG. 1, the electronic unit and the bank server both have a same customer table 80. This customer table is stored in the server 50 in such a way that it cannot be accessed via the internet. The electronic unit is in a format resembling a conventional credit card and has a touch-sensitive keyboard and a digital screen, such a card having already been described in the literature (FR 2,768,532).

There now follows a description of a transaction procedure according to the invention with particular reference to FIG. 1.

Using the personal computer 40, the customer 10 contacts the server 60 of the trader 30. The notions of customer and trader can be broadened to any transmission link connecting a party transmitting a signed data item and a party wishing to receive this data item with the assurance that the signature indeed designates the transmitting party. The customer has access to the trader server via the internet network. We shall assume that he has already chosen goods he wishes to obtain. To pay for the purchase, the trader 30 then asks the customer 10 to transmit an identifier, which can for example be his name if this is sufficiently unique, or an identifier defined in advance with the trusted third party 20, which is a bank. As an example, this identifier is the serial number 100 of the electronic unit 70, which is unique and indicated on said unit. The trader also asks for a purchase number and a certification number, which can be a numerical, alphanumerical or alphabetic code.

In step 1 in FIG. 1, the customer is recognized by his electronic unit by entering an individual signature code, for example in the form of a 4-digit code, commonly referred to as a (Personal Identification Number) PIN code. The electronic unit is equipped with a monitoring component which checks the validity of this code, and temporarily or permanently blocks its use after a defined number of input errors, for example after three failed attempts in succession.

After validation of the PIN code, the electronic system issues the customer with a purchase number originating from an internal counter. This number is incremented by one unit each time the customer accesses a certification number. It therefore corresponds to the number of purchases, or certification number requests, carried out by the customer.

The customer table stored in the electronic unit's memory matches a certification number randomly defined on initialization of the unit by the bank with each purchase number.

In step 2, the customer enters his identifier, the purchase number and the certification number issued by the electronic unit 70 into his personal computer 40 in order transmit them in step 3 to the server 60 of the trader 30. This triple entry can for example be constituted respectively by data: “1234” for the identifier; “004” for the purchase number; and “43B1” for the certification number. This transmission is preferably secured using conventional techniques. The trader then generates an invoice 90 containing the triple entry transmitted by the customer together with information relating to the goods desired by the customer, for example the price of these goods. In step 4, the trader contacts the company issuing the system providing the invoice 90 via the internet in a manner secured using known techniques. The bank checks the validity of this information using the duplicate customer table it holds and records the use of this purchase number. In step 5, it provides the trader with a transaction approval when, for the customer identified via identifier “1234” and for purchase number “004”, the certification number “43B1” does correspond to the certification number present in the customer table stored in the server 50. The bank has first taken the precaution of checking that the purchase number has been used for the first time for that customer. The bank can also pay for the order directly from the customer's account, and optionally in step 6 send the customer a receipt, for example by e-mail. If the bank subsequently receives a purchase invoice containing a purchase number or a certification number already used, it will decline that invoice, and optionally advise the identified customer of this, for example by e-mail or any other means.

When the trader receives the bank's approval in step 5, he can then transmit the goods ordered by the customer in step 7.

The duration between the moment when the customer transmits the information (serial number, purchase number, certification number) and the moment when the bank records this use must be as short as possible. Thus if this duration remains shorter than the time needed for fraudulent use, total system security can be evoked. A time stamp of TSA type (Time Stamping Authority, a technology being researched by ETSI, the European Telecommunications Standards Institute, ETSI TS 101 861, http://www.etsi.org). This time stamp is input encrypted, via the customer's personal computer, into the transaction data item transmitted to the bank server. On reception, the bank server decrypts the time stamp, compares it with updated time data on a TSA server for example, and can thus produce an elapsed time error on the transaction if the time elapsed between transmission and reception appears to exceed a predefined normal transmission duration.

FIG. 3 is a flow chart starting at step 150 and illustrating different steps necessary for accessing the purchase number and the certification number, these steps being carried out by the logical circuit 110 of the electronic unit. In step 170, the variable “x”, for example equal to 3 in step 150, represents the maximum number of attempts to enter an incorrect PIN code. If “x” is equal to zero, the logical circuit displays “PIN error” in step 160 and blocks. Possible unblocking requires intervention by the issuing company, namely the bank 20.

When “x” is different from zero, the customer can enter his PIN code and press the “Enter” key in step 180. The logical circuit then compares this PIN code with a pre-loaded code in step 190. If the PIN code is incorrect, step 200 is carried out while decrementing the variable “x” by one unit, then step 170 is repeated.

When the PIN code is correct, the purchase number and the certification number are displayed in step 210. Then the logical circuit waits for a period of five minutes, which can be interrupted by pressing the “Cancel” key. After this time, the logical circuit increments the purchase number by one unit in step 230, then in step 240 checks whether this number is equal to 999, which represents the last possible value of the purchase number in the customer table. When the purchase number reaches the value 999, “card expired” is displayed in step 250 and the logical circuit blocks, otherwise the procedure starts again at 150.

The electronic unit can be a mobile telephone or a personal information manager, integrating the logical circuit/customer table assembly. However, when the interface used is a device which can be connected to a communications network, particular care will preferably be taken to strictly prevent reading of table data by any access external to the medium other than the man/machine interface described above. As can be seen in FIG. 4, a mobile telephone 260 is used as a simple reader into which a transaction module 290 is placed containing the customer table 80, an identifier 300 and the logical circuit 110 capable of controlling the steps illustrated in FIG. 3. The man/machine interface 270 is either in communication with the transaction module 290 or in communication with a telephony module 280 required to carry out at least the mobile telephony function. The telephone only provides a man/machine interface. When the customer executes the process for obtaining the purchase number and the certification number, these two numbers can be memorized by the customer or preferably stored in a buffer memory. Once the telephone is connected to the wireless network, the purchase and certification numbers can then be transmitted from this buffer memory.

The transmission of data (serial number/purchase number/certification number) can thus be carried out using a wired or wireless telephone network in the form of a digital signal.

Of course, the invention is not limited to the examples which have just been described and numerous adjustments can be made to these examples without exceeding the scope of the invention, in particular the system according to the invention can be used for processing other than purchasing goods, for example processes for transmitting information, exchanging a contract requiring authentication, etc. An automatic mode can also be envisaged for example between a trader server and a customer server, the customer server having access to a program for issuing purchase and certification numbers independently of the connection to the communications network.

1. Secure transaction system via a communications network, comprising a customer (10) terminal (40) for connecting to said communications network and transmitting a transaction request and a certification data item, a trader server (60) for receiving the transaction request from the customer, a trusted third party (20) server (50) for receiving and validating the certification information, a processing module (70) located on the customer's premises and comprising a customer table (80) containing the certification information, this certification information being unique for each transaction and composed by a transaction number associated with a unique certification number determined on creation of the customer table, characterized in that the trusted third party server comprises a duplicate of this customer table (80) in order to validate the certification information by checking that this certification information has not previously been used, the data in the customer table not being legible via the communications network.

2. System according to claim 1, characterized in that the processing module (70) further comprises processing means (110) for providing on each request a new transaction number and a new associated certification number.

3. System according to one of claims 1 and 2, characterized in that each certification number is a random number.

4. System according to any one of the previous claims, characterized in that the processing module (70) comprises means for locking and unlocking access to the customer table, the unlocking being obtained using a secret code.

5. System according to any one of the previous claims, characterized in that the transaction request comprises a customer identification code.

6. System according to claim 5, characterized in that the processing module comprises a unique serial number (100) serving as a customer identification code.

7. System according to any one of the previous claims, characterized in that the processing module comprises at least one keyboard (140) with ten keys numbered from 0 to 9, and two keys offering validation and cancellation functions.

8. System according to any one of the previous claims, characterized in that the processing module comprises a display screen (130).

9. System according to any one of the previous claims, characterized in that the processing module comprises a touch-sensitive screen.

10. System according to any one of claims 1 to 3, characterized in that the processing module is equipped with a mechanical technology.

11. System according to any one of the previous claims, characterized in that the processing module is in the format of a standard credit card.

12. System according to any one of claims 1 to 9, characterized in that the processing module is a mobile telephone (260).

13. System according to any one of claims 1 to 9, characterized in that the processing module is a personal organizer.

14. System according to any one of the previous claims, characterized in that the trusted third party is a bank.

15. Secure transaction process via a communications network, in which a customer (10) connects, via a terminal (40), to a trader server (60) in order to make a transaction, characterized in that it comprises the following steps:
generation of a certification data item from a customer table (80) stored in a processing module (70) in the customer's possession, this table being isolated from the communications network,
transmission of the certification data item to a trusted third party (20) server (50), this trusted third party server containing a duplicate of the customer table (80),
reception of the certification data item by the trusted third party server and comparison of this data item with the customer table stored in the trusted third party server,
validation of the purchase when the comparison is positive.

16. Process according to claim 15, characterized in that the comparison is positive when the certification data item is contained in the customer table stored in the trusted third party server and the trusted third party server receives this certification data item for the first time.

17. Process according to one of claims 15 and 16, characterized in that the certification data item is generated by taking from the customer table stored in the processing module a transaction number associated with a certification number.

18. Process according to claim 17, characterized in that the comparison is positive when the trusted third party server receives a transaction number and a certification number which have not yet been used.

19. Process according to one of claims 17 and 18, characterized in that the comparison consists of checking whether, for a transaction number contained in the certification data item received, the associated certification number is identical to that contained in the customer table stored in the trusted third party server.

20. Process according to any one of claims 17 to 19, characterized in that the transaction number is incremented such that, for each request from the processing module, a new transaction number is generated.

21. Process according to any one of claims 15 to 20, characterized in that the certification data item is transmitted accompanied by an identification code allowing the customer to be identified.

22. Process according to claim 21, characterized in that the customer identification code is determined from the serial number (100) of the processing module.

23. Process according to any one of claims 15 to 22, characterized in that the certification data item transits (3, 4) via the trader server, which transmits it to the trusted third party server.

24. Process according to any one of claims 15 to 23, characterized in that the customer table comprises a series of transaction numbers such that a unique certification number is determined from each transaction number using an algorithm.

25. Process according to any one of claims 15 to 24, characterized in that the trusted third party server notifies (6) the customer of the result of the comparison.

26. Process according to any one of claims 15 to 25, characterized in that the certification data item further comprises a time stamp allowing the trusted third party server to determine the duration between the transmission and the reception of this certification data item.
